(19) United States
(12) Patent Application Publication
(10) Pub. No.: US 2015/0359214 A1
(43) Pub. Date: Dec. 17, 2015

(54) PLANTS PRESERVATION DEVICE

(71) Applicant: Moshe Sasson, Moshav Olesh (IL)

(72) Inventor: Moshe Sasson, Moshav Olesh (IL)

(21) Appl. No.: 14/763,835

(22) PCT Filed: Jan. 28, 2014
(86) PCT No.: PCT/IL2014/050092

§ 371 Date: Jul. 28, 2015

Related U.S. Application Data
(60) Provisional application No. 61/757,239, filed on Jan. 28, 2013.

(51) Int. Cl. A01N 3/02; A01G 7/06

(52) U.S. Cl. CPC A01N 3/02; A01G 7/06

(57) ABSTRACT

The present invention provides a slow-release plant preservation device for use in an aqueous environment and method of use thereof to increase plants vitality, the device comprising a preservation composition that is slowly released into the aqueous environment.

### FIELD OF THE INVENTION

The present invention provides methods, devices and compositions to preserve plants, such as up-rooted and cut flowers. The present invention relates to, e.g., methods to preserve the freshness of cut or rooted plants and/or flowers by providing preservatives, fertilizers and/or vitalizing agents thereto. The plant preservation devices of the invention include, e.g., ribbons (23), bands (22) and threads, which comprise, e.g., preservatives, antimicrobial agents and food materials (fertilizers). The devices of the invention may be made of any suitable substance, e.g., cellulose or any synthetic material, such as polyester, plastic, rubber, nylon and polypropylene. The compositions suitable for use with the device of the invention comprise, e.g., preservatives, microbe growth inhibitors and vitalizing agents, such as sugars, salts, nutrients, etc.

### BACKGROUND OF THE INVENTION

The importance of preserving rooted plants and cut flowers continues to grow as consumers demand a greater selection of plants and flowers from around the world. However, despite the improvement in the preservation of said plants and flowers during shipment and storage, most have a short life span after purchase, i.e. in the vase at the consumer's home. Today, consumers demand florists to provide a variety of non-indigenous plants, and out of season flowers, and expect said flowers and plants to remain vital and beautiful for a long period of time. In order to achieve better liveliness and prolong the flower's vitality, florists offer the consumer different techniques, such as cutting the end of the flower's stems every other day, replacing the water in the vase, and also provide various additives to be admixed with the vase water.

One requirement for preservation of uprooted or cut plants is fresh water. Many flowers and plant parts quickly lose turgidity and wilt without a ready supply of water. As such, it is common practice to increase the attractive life of flowers by refilling and changing the vase water, which may also be infested. This approach, though useful, provide only a short respite from wilting and degradation for must plants and flowers. Moreover, many consumers fail to perform this simple step, either due to lack of knowledge or due to laziness. Moreover, the bag of additives provided by the florist is often misplaced or lost on the way home, and even if used must be re-added whenever refilling or replacing the water.

The addition of preservatives, salts and sugars to the water of cut flowers and plants is known to maintain an appropriate osmotic balance, and has been shown to forestall wilting of cut flowers. However, these preservatives, salts and sugars must be constantly renewed in order to maintain prolong vitality of the plant or flower, due to the replacement of water and due to their uptake by the plant.

Microbes are also known to degrade the appearance of plants and cut flowers, and can cause premature wilting of the flowers. A variety of methods have been used to combat microbial destruction of plants and cut flowers, such as the use of sterilization, refrigeration, application of biocides, and the use of antibiotics. However, these techniques are only useful under controlled environment which is absent at the consumer's home, where, among other, the vase water constitutes a fertile soil for bacteria growth, which leads to fast degradation of the plants and flowers, and also to the release of bad odors to the surroundings.

In view of the above, a need exists for ways to maintain the vitality of purchased plants and flowers at the consumer's home. It is thus an object of this invention to provide methods and devices enabling to maintain the vitality and liveliness of plants and flowers placed in a vase for a prolong time.

Other objects and advantages of the present invention will appear as description proceeds.

### SUMMARY OF THE INVENTION

In one aspect, the present invention provides a slow-release plant preservation device for use in an aqueous environment in a vessel to increase the vitality of one or more plants placed within said vessel, the device comprising a preservation composition that is slowly released into the aqueous environment in the vessel, wherein said preservation composition comprises at least one preservative and at least one vitalizing agent, wherein said one or more plants comprise any combination of uprooted plants and cut flowers, and wherein the device is adapted for binding said one or more plants together.

In another aspect, the present invention relates to a method of preserving a plant, comprising rapping a plant or a group of plants, or binding them together with the slow-release plant preservation device of any one of the preceding claims and placing the same in a water containing vessel, wherein said plant or a group of plants comprise any combination of uprooted plants and cut flowers.

### BRIEF DESCRIPTION OF THE DRAWINGS

The above and other characteristics and advantages of the invention will be more readily apparent through the following examples, and with reference to the appended drawings, wherein:

FIG. 1. is a schematic diagram of an exemplary flower preservation device of the invention.

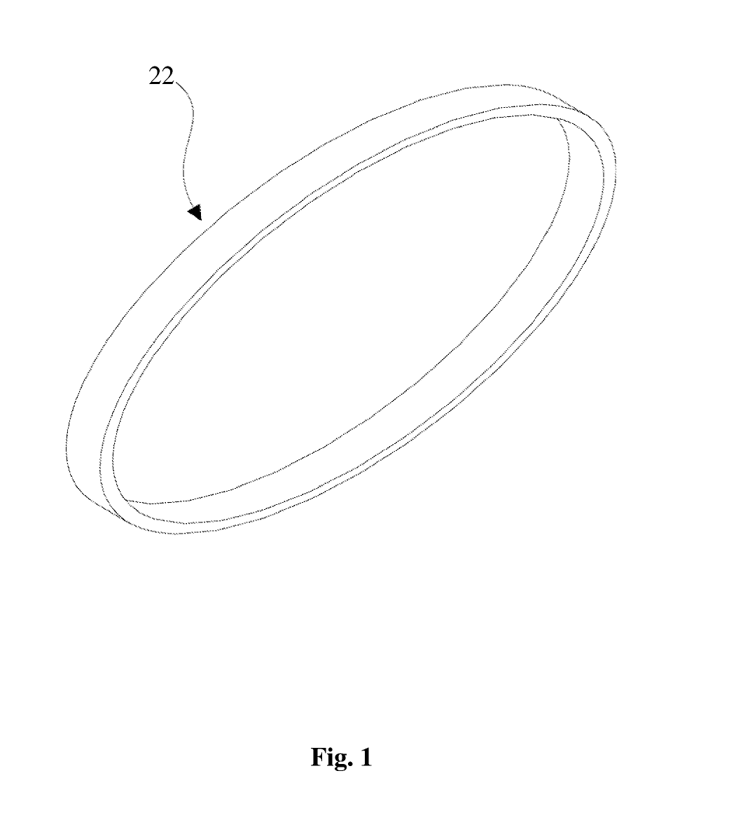

FIG. 2. is a schematic diagram illustrating the diffusion of the preservatives and other additives from the preservation device of the invention into the surrounding water.

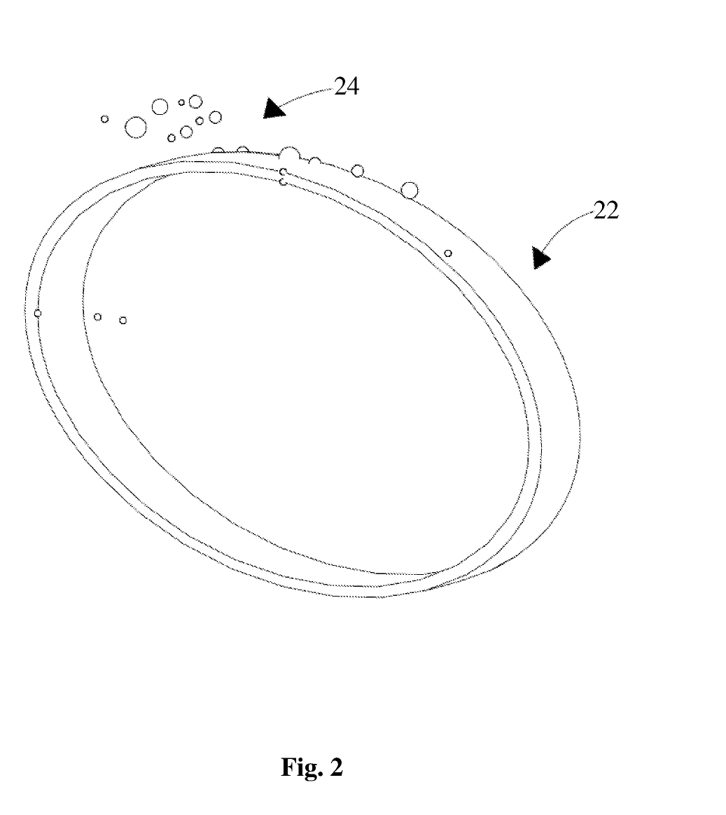

FIG. 3. shows two possible schematic cut-out sections of the preservation device of the invention: (B) microcapsules (30) containing the composition and embedded within a solid band (22); and (C) a hollow tube (31) inside the band (22) containing the composition.

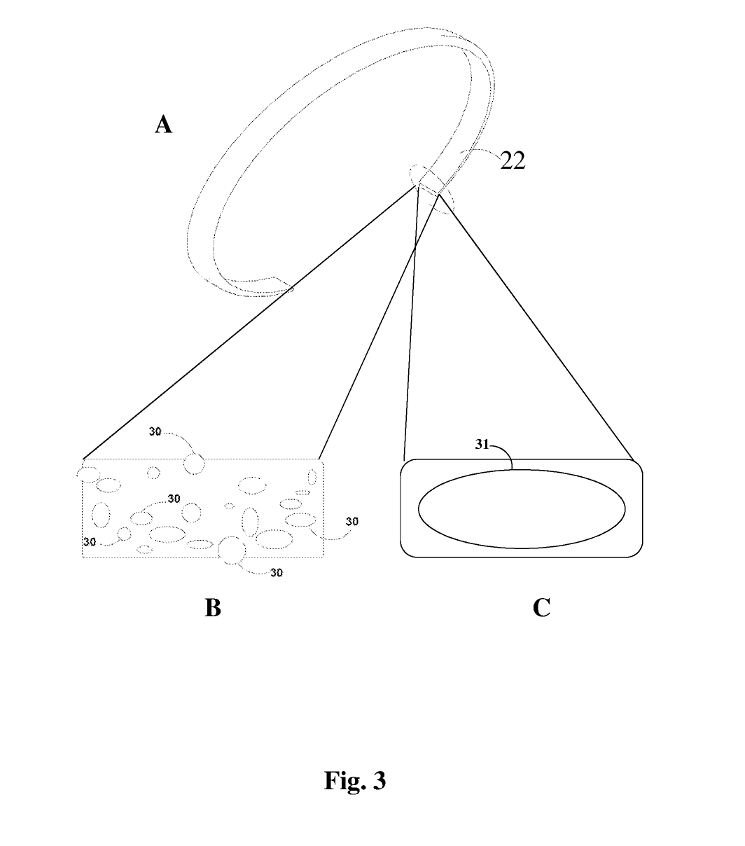

FIG. 4. shows two more possible schematic cut-out sections of the preservation device of the invention, wherein the devise is rounded: (B) microcapsules (30) containing the composition and embedded within a solid band (22); and (C) a hollow tube (31) inside the band (22) containing the composition.

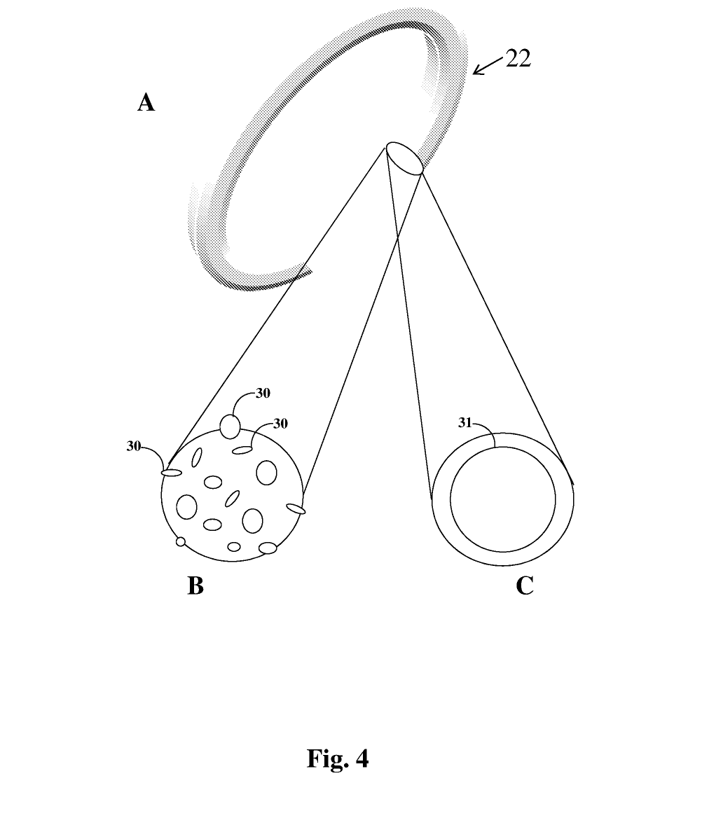

FIG. 5. is a scheme of a ribbon (23) of the invention, either shaped as a stripe (A) or as a rounded string (B).

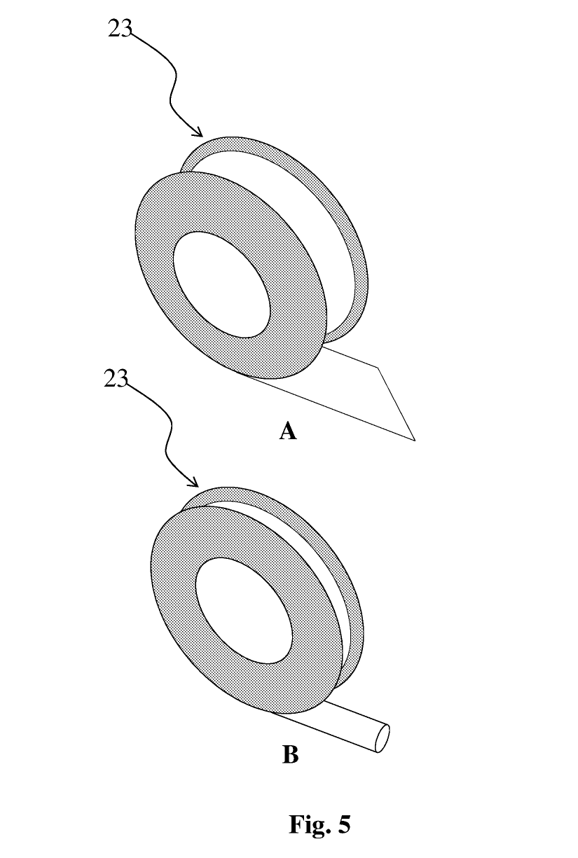

FIG. 6. illustrates an embodiment of the invention where the flowers in the vase are bound together with a decorative ribbon (23) device of the invention comprising the preservative composition of the invention.

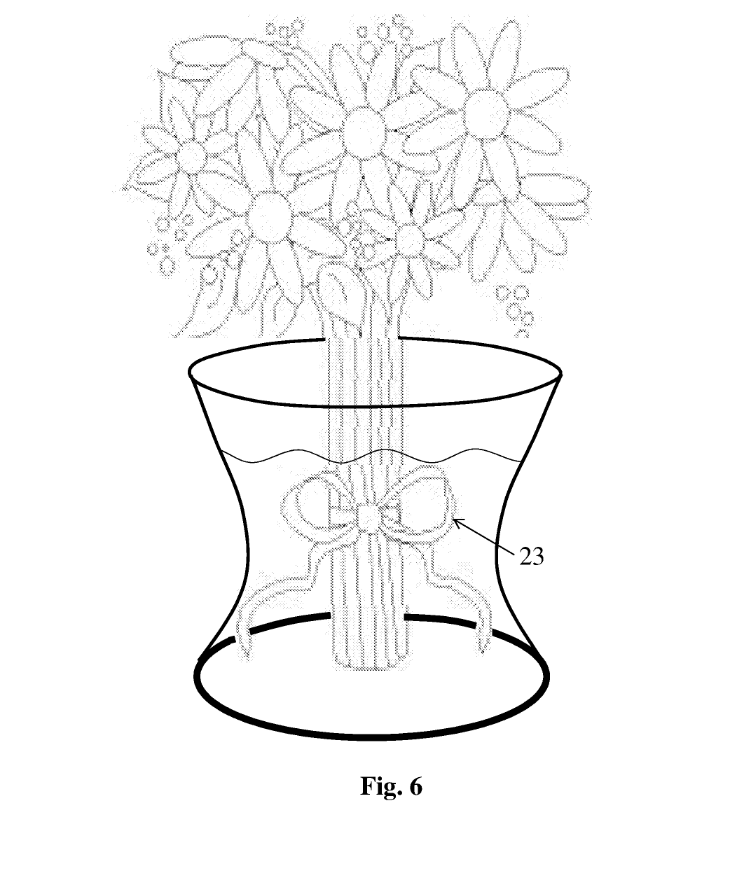

FIG. 7. illustrates another embodiment of the invention where the flowers in the vase are bound together with a rubber band device (22) of the invention comprising the preservative composition of the invention, and further illustrates the release (24) of the composition from the band.

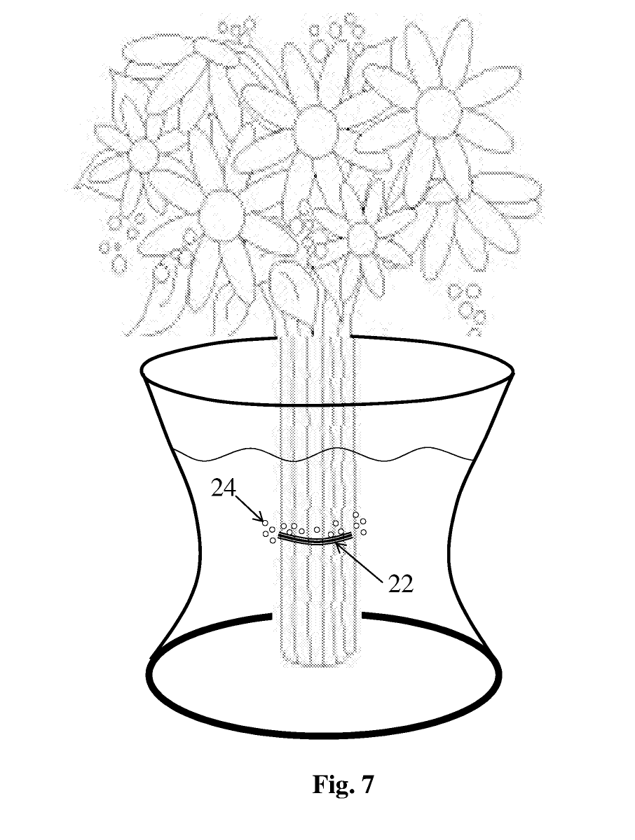

### DETAILED DESCRIPTION OF THE INVENTION

It has now been found that uprooted plants and cut flowers can last longer while maintaining their vitality and good looks by simply placing them in water together with the preservation device of the invention.

The invention thus relates to a novel preservation device, capable to preserve the vitality and beauty of cut flowers and rooted plants for a prolong time, e.g. of up to 3 weeks. The preservation device of the invention has the effects of enhancing the immunity of cells, easing the aging rate of flower's cells and really prolonging the observing service life of the fresh cut flower by at least 2 times or longer, compared to similar vase flowers and plants without the device.

It should be noted that the term “plant” as used herein refers to, e.g., one or more whole plants, rooted or uprooted plants and/or cut plants, including flowers and cut flowers, and may include isolated flower branches, flowers, fruit and other plant organs.

Plants, such as fresh cut flowers and up-rooted plants, which are placed in water in a vase, usually have only 3 to 10 days of vase life. In order to maintain the quality of such plants in a vase at the consumer's house, it is essential to provide the plant essential nutrition elements while preventing growth of harmful pathogens, e.g. bacteria, which propagates cell death and overall degradation.

Thus, one purpose of the present invention is to overcome the deficiencies of the prior art and presently used techniques, which forces the user to cut the flowers stem every now and then, daily replacing the water in the vase, and sometimes adding nutrients to the vase water. Accordingly, the present invention provides a simple to use device, which is readily available to everyone, that can fulfill all the flower's needs while preventing bacteria growth, thereby preventing and/or slowing aging and deteriorating of the plant while maintaining its liveliness and beauty.

In one aspect, the present invention provides a slow-release plant preservation device for use in an aqueous environment in a vessel to increase the vitality of one or more plants placed within said vessel, the device comprising a preservation composition that is slowly released into the aqueous environment in the vessel, wherein said preservation composition comprises at least one preservative and at least one vitalizing agent, wherein said one or more plants comprise any combination of uprooted plants and cut flowers, and wherein the device is adapted for binding said one or more plants together. In a specific aspect, the vitalizing agent comprises: salts, sugars and vitamins.

The preservation devices of the present invention can be configured to suite various requirements of different flowers and conditions. The flower preservation devices of the invention can protect cut flowers or rooted flowers. The flowers can be of any type, e.g. roses, lilies, tulips, alstroemeria, carnations, chrysanthemums and orchids, or can be present in mixed bouquets. The devices can preserve at least one plant or flower or a bouquet of any number of flowers. In some cases, the flowers have unopened blossoms (buds) or partially opened flower blossoms. The flowers typically include stems with leaves.

Use of the preservative device of the invention on plants and flowers is highly beneficial, as it not only sterilizes the vase water, but it also provides nutrition, prevents shedding petals, prevents premature decay and degradation, and significantly improves the quality and appearance of the flowers for an extended time when placed in a vase.

According to some embodiment of the invention, there is provided a plant preservation device comprising any combination of at least one preservative, an antimicrobial composition, nutrients and essential salts, which is suitable for preventing microbial growth in the vase water as well as providing the flower/plant with all its essentials.

According to another embodiment of the invention, the preservative comprises: antimicrobial-, antibiotic-, antiseptic- and anti-fungal-agent. According to a specific embodiment of the invention, the preservative comprises: copper sulfate, citric acid, baking soda, salt, nitric oxide (NO), sorbates, sulfites benzoates, hypochlorite, silver nitrate, and 8-hydroxyquinoline.

According to some embodiment of the invention, the preservative composition in the slow-release plant preservation device of the invention comprises additives comprising: ammonium nitrate, boric acid, calcium chloride, cobalt chloride, cupric sulfate, EDTA, ferrous sulfate, magnesium sulfate, sodium molybdate, potassium iodide, potassium nitrate, potassium phosphate, zinc sulfate, myo-inositol, nicotinic acid, pyridoxine, thiamine and kinetin.

According to another embodiment of the invention, the slow-release plant preservation device of the invention, slowly releases the composition embedded therewithin over time during a period of about 3 days to about 3 weeks. thus maintaining sufficient levels of preservatives, antimicrobial agents, nutrients and salts for at least 3 weeks. In a specific embodiment, these sufficient levels or the concentration of the composition in the aqueous environment is not affected by the addition of water to the vase or by their replacement and is maintained essentially constant.

Usually, preservatives are lost due to the replacement of the vase water. Accordingly, there is an increased interest in developing slow release fertilizers and preservatives that release nutrients and preservatives to the vase water over time. Some advantages of the slow release device of the present invention are, among other, continuous supply of nutrients and preservatives to the vase water and redistribution thereof in case the water is replaced in the vase.

According to yet another embodiment of the invention there is provided a method of preserving plant's vitality and preventing microbial growth in the vase water, the method comprising the step of binding cut flowers or rooted plants with the device of the invention, and placing them in a vessel, e.g. vase, with water. The method may further comprise daily replacement of the water in said vessel, addition of water when needed, and/or periodically cutting the stems of the flowers.

In another aspect, the present invention relates to a method of preserving a plant, comprising rapping a plant or a group of plants, or binding them together with the slow-release plant preservation device of any one of the preceding claims and placing the same in a water containing vessel, wherein said plant or a group of plants comprise any combination of uprooted plants and cut flowers.

In yet another embodiment, the method of the invention for preserving a plant further comprise the addition of water to the vessel when necessary, e.g. when the water level drops below the level of the device on the stems. Said method may further comprise the replacement of the vessel water when necessary, and/or cutting the flower's stem from time to time.

The compositions used in the preservation device of the invention may be adjusted to suit requirements of specific plants or flowers. The composition may contain biological salts, lipids or lipid derivatives, polysaccharides or polysaccharide derivatives, sugars or sugar derivatives. The composition may also include one or more other antimicrobial or antifungal compounds, including natural peptides, lipopeptides or antibiotics from animal, microbial or plant origin or chemically produced biocides or antibiotics. The composition may include a combination of one or more tyrocidines and gramicidin S or derivatives thereof. The composition may include methylchloroisothiazolinone/methylisothiazolinone which inhibits the growth of both bacterial and fungal pathogens.

The term preservative as appears herein refers to any natural occurring or synthetically produced substance that is added to the composition of the invention in order to prevent decomposition by microbial growth or by undesirable chemical changes. Examples of preservatives include, but not limited to, salts, sugars, sorbates, sulfites and benzoates. The preservative can help preserve the freshness of the flowers. Preservatives, such as hormones, like IAA, and/or antimicrobial agents can dissolve in water to provide, e.g., appropriate metabolic signals to the flowers and/or reduce microbial infestation. Examples of suitable preservatives are auxin, cytokinin, copper sulfate, citric acid, baking soda, salts and vitamins. Other types of suitable preservative are plant hormones, antibiotics, antiseptics (e.g., chemical bactericidals), fertilizing salts, sugars, and the like.

In a specific aspect, the preservation composition in the slow-release plant preservation device of the invention, further comprises at least one plant hormone. For example purposes, said plant hormone comprises: auxin, cytokinin, gibberellins, brassinosteroids, salicylic acid, jasmonates, indole-3-acetic acid (IAA), peptides and polyamines

The term plant hormones (also known as phytohormones) as mentioned herein means chemicals that regulate cellular processes and thereby affect plant growth, blooming, flowering time, leaves shedding, pellets loss, and plant death.

The term “antimicrobial” includes, but is not limited to, antibiotics, anti-fungal agents, antiseptics, antimicrobial plant compositions and extracts that can kill or slow the growth of microbes. Bactericides are materials, other than antibiotics, that kill bacteria, on contact, such as antiseptics. Antibiotics are not considered antiseptics and include bactericidal or bacteriostatic antibiotics.

The terms “slow-release”, “sustained-release” or “controlled-release” as used herein refer to the distribution of the active agent(s) at a slow, controlled rate over time, preferably between 3 days and 3 weeks. The slow release is achieved by any known way, such as encapsulation, e.g. polymer coating, coating breakdown, etc., using chemical binder(s), placing the active agent(s) within a porous membrane, etc.

Encapsulated fertilizers are known source of slow release nutrients for long-term feeding of plants. The nutrients are released at slow, controlled rates through the fertilizer's coating resulting in a sustained feeding of the plants. As a result, one application of an encapsulated fertilizer can provide the necessary nutrients for a plant that would ordinarily take multiple applications of soluble fertilizers. However, most, if not all, of the present slow release fertilizers are designated for use in the soil, and are not suited for use in an aqueous environment.

On the other hand, the preservative device of the invention is perfectly suited for use in an aqueous environment, and offers certain advantages over known fertilizers and preservative techniques, such as simplicity of use, providing constant release of nutrients and preservatives, and being less costly than others.

The preservative devices of the invention may be made from any suitable substance or combinations thereof, e.g., organic polymer such as cellulose or any synthetic material or polymer, such as polyester, plastic, rubber, nylon and polypropylene. The preservative device may be prepared by any known technique, including but not limited to, injection molding, dynamic forging, stamp forging, sheet forming, and blow molding. The preservative composition of the invention may be incorporated into the preservative device during its preparation, e.g. by admixing microcapsules of the composition together with the polymer of choice prior to the final fabrication process, or may alternatively be added to the final prepared device, e.g. by filling a hollow band with the composition of the invention or by immersing the device (e.g. a string or a thread) in a solution containing the desired composition.

In one aspect, the slow-release plant preservation device of the invention is in the form of: a band (22), thin film, string, tape, strap, ribbon (23) and thread. Said device may be elastic, e.g. a rubber or silicone band (22).

In yet another specific aspect, the slow-release plant preservation device of the invention is suitable for wrapping around the stems of a plant at a level along the stems that enables contact with the aqueous environment, e.g. water, in the vessel, e.g. vase.

While the present invention is useful for the controlled release of a variety of active agents, it is primarily useful for the sustained release of water soluble preservatives. It is to be recognized that the controlled-release agents suitable for use in the preservative device of the invention include any desirable agent, including pesticides, fungicides, growth regulators, insecticides and animal and insect repellents.

Unless otherwise defined herein or below in the remainder of the specification, all technical and scientific terms used herein have meanings commonly understood by those of ordinary skill in the art to which the present invention belongs.

Before describing the present invention in further detail, it is to be understood that this invention is not limited to particular plant preservation composition, which can, of course, vary. It is also to be understood that the terminology used herein is for the purpose of describing particular embodiments only, and is not intended to be limiting.

As used in this specification and the appended claims, the singular forms “a”, “an” and “the” include plural referents unless the content clearly dictates otherwise. Thus, for example, reference to “a component” can include a combination of two or more components; reference to “a liquid” can include mixtures of liquids, and the like.

The invention will be further described and illustrated in the following examples.

### EXAMPLES

The following are examples of some of the devices and compositions which are covered by the invention.

### Example 1

A rubber band (22) comprising a composition comprising essentially of the following:
0.4% Bronopol;
5.1% Citric acid;
94.5% Dextrose.

The composition is encapsulated in slow-release capsules embedded within the band (22).

### Example 2

A ribbon (23) comprising a composition comprising essentially of the following:
0.5% Sulfite;
4.5% Lactic acid;
95% Galactose.

The composition is incorporated into the ribbon (23) during its preparation, wherein the ribbon (23) slowly dissolves in water and releases them.

### Example 3

A thread comprising a composition comprising essentially of the following:
0.7% Benzoate;
4.3% Acetic acid;
2% Salt
93% Fructose.

The thread is soaked in the composition and slowly releases it into the water.

### Example 4

A band (22) comprising a composition comprising essentially of the following:
0.3% Hypochlorite;
3% Bleach;
96.7% Dextrose.

The composition is placed in an inner tube (31) inside the band (22) and slowly released into the water through pores in the band (22).

While this invention has been described in terms of some specific examples, many modifications and variations are possible. It is therefore understood that within the scope of the appended claims, the invention may be realized otherwise than as specifically described.

1. A slow-release plant preservation device for use in an aqueous environment in a vessel to increase the vitality of one or more plants placed within said vessel, the device comprising a preservation composition that is slowly released into the aqueous environment in the vessel, wherein said preservation composition comprises at least one preservative and at least one vitalizing agent, wherein said one or more plants comprise any combination of uprooted plants and cut flowers, and wherein the device is adapted for binding said one or more plants together.

2. The slow-release plant preservation device of claim 1, wherein the preservation composition further comprises at least one plant hormone.

3. The slow-release plant preservation device of claim 2, wherein the at least one plant hormone comprises: auxin, cytokinin, gibberellins, brassinosteroids, salicylic acid, jasmonates, indole-3-acetic acid (IAA), peptides and polyamines.

4. The slow-release plant preservation device of claim 1, which is in the form of: a band (22), thin film, string, tape, strap, ribbon (23) and thread.

5. The slow-release plant preservation device of claim 4, which is elastic, e.g. a rubber band (22).

6. The slow-release plant preservation device of claim 1, which is suitable for wrapping around the stems of a plant at a level along the stems that enables contact with the aqueous environment, e.g. water, in the vessel, e.g. vase.

7. The slow-release plant preservation device of claim 1, wherein the at least one preservative comprises: antimicrobial-, antibiotic-, antiseptic- and anti-fungal-agent.

8. The slow-release plant preservation device of claim 1, wherein the at least one preservative comprises: copper sulfate, citric acid, baking soda, salt, nitric oxide (NO), sorbates, sulfites benzoates, hypochlorite, silver nitrate, and 8-hydroxyquinoline.

9. The slow-release plant preservation device of claim 1, wherein the at least one vitalizing agent comprises: salts, sugars and vitamins.

10. The slow-release plant preservation device of any one of the preceding claims claim 1, wherein the preservative composition comprises additives comprising: ammonium nitrate, boric acid, calcium chloride, cobalt chloride, cupric sulfate, EDTA, ferrous sulfate, magnesium sulfate, sodium molybdate, potassium iodide, potassium nitrate, potassium phosphate, zinc sulfate, myo-inositol, nicotinic acid, pyridoxine, thiamine and kinetin.

11. The slow-release plant preservation device of any one of the preceding claims claim 1, which is suitable to preserve at least 1 plant or flower and up to 50 plants and/or flowers.

12. The slow-release plant preservation device of any one of the preceding claims claim 1, which slowly releases the composition embedded therewithin during a period of about 3 days to about 3 weeks.

13. The slow-release plant preservation device of claim 12, wherein the concentration of the composition in the aqueous environment is maintained essentially constant.

14. A method of preserving a plant, comprising rapping a plant or a group of plants, or binding them together with the slow-release plant preservation device of any one of the preceding claims claim 1 and placing the same in a water containing vessel, wherein said plant or a group of plants comprise any combination of uprooted plants and cut flowers.

15. The method of claim 14, further comprising: (i) adding water to the vessel when necessary, e.g. when the water level drops below the level of the device on the stems; (ii) replacing the vessel water when necessary; and/or (iii) cutting the flower's stem from time to time.

16-17. (canceled)
